(19) United States
(12) Patent Application Publication
(10) Pub. No.: US 2025/0142457 A1
(43) Pub. Date: May 1, 2025

(54) COMMUNICATION METHOD AND ELECTRONIC DEVICE

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/833,320

(22) PCT Filed: Jan. 26, 2022
(86) PCT No.: PCT/CN2022/074055

§ 371 Date: Jul. 25, 2024

(51) Int. Cl. H04W 48/14; H04L 5/00; H04W 84/12

(52) U.S. Cl. CPC H04W 48/14; H04L 5/0053; H04W 84/12

(57) ABSTRACT

A communication method, performed by an access point (AP), where the method includes: sending a first radio frame, wherein the first radio frame comprises proxy response information, the proxy response information indicates that the AP rejects a sensing measurement proxy request of an initiator or accepts the sensing measurement proxy request, and the sensing measurement proxy request indicates that the AP sets up a wireless local area network (WLAN) sensing measurement as a proxy of the initiator.

### CROSS REFERENCE

The present application is a U.S. National Stage of International Application No. PCT/CN2022/074055, filed on Jan. 26, 2022, all contents of which are incorporated herein by reference in their entireties for all purposes.

### TECHNICAL FIELD

Embodiments of the present disclosure relate to the field of mobile communication technologies, and in particular, to a communication method and apparatus, an electronic device, and a non-transitory computer storage medium.

### BACKGROUND

With the rapid development of mobile communication technologies, wireless fidelity (Wi-Fi) technology has made great progress in terms of transmission rate, throughput, or the like. At present, the content studied for the Wi-Fi technology is, for example, 320 MHz bandwidth transmission, aggregation and collaboration of multiple frequency bands, etc. The main application scenarios include, for example, video transmission, augmented reality (AR), virtual reality (VR), etc.

In the currently studied Wi-Fi technology, a wireless local area network (WLAN) sensing technology may be supported, for example, in application scenarios such as location discovery, proximity detection, and presence detection in a dense environment (for example, a home environment and an enterprise environment). In the WLAN sensing process, the identity of a station (STA) and the identity of an access point (AP) may generally be interchanged; for example, both of them may be used as sensing initiators or sensing transmitters. When used as a sensing initiator or a sensing transmitter, the AP may communicate with a plurality of STAs at the same time; however, the STA does not have the foregoing function, and can only communicate with a single sensing responder in a one-to-one manner. Therefore, on one hand, spectrum resource waste is caused; and on the other hand, increasing of latency is caused. For a communication scenario with a relatively higher latency requirement, the latency requirement may not be satisfied. In order to solve the problem, there is proposed a manner that an AP performs the sensing measurement as a proxy of the STA, and it is needed to continue to improve the measurement process that the AP initiates the sensing measurement as the proxy of the STA.

### SUMMARY

In an aspect, according to embodiments of the present disclosure, there is provided a communication method, performed by an access point (AP), and the method includes:
sending a first radio frame, where the first radio frame includes proxy response information, the proxy response information indicates that the AP rejects a sensing measurement proxy request of an initiator or accepts the sensing measurement proxy request, and the sensing measurement proxy request indicates that the AP sets up a wireless local area network (WLAN) sensing measurement as a proxy of the initiator.

In another aspect, according to embodiments of the present disclosure, there is provided a communication method, performed by a station (STA), and the method includes:
receiving a first radio frame, where the first radio frame includes proxy response information, the proxy response information indicates that an AP rejects a sensing measurement proxy request of the STA or accepts the sensing measurement proxy request, and the sensing measurement proxy request indicates that the AP sets up a WLAN sensing measurement as a proxy of the STA.

According to embodiments of the present disclosure, there is further provided an electronic device, including a memory and a processor, wherein the memory stores a computer program, which when executed by the processor, causes the electronic device to perform the method according to one or more of the embodiments of the present disclosure.

### BRIEF DESCRIPTION OF THE DRAWINGS

In order to more clearly illustrate the technical solutions of the embodiments of the present disclosure, the drawings required in the description of the embodiments of the present disclosure will be briefly described below. Obviously, the drawings in the following description are some embodiments of the present disclosure, and for those of ordinary skill in the art, other drawings can also be obtained from these drawings without creative efforts.

FIG. 1 is a first flowchart of a communication method provided according to an embodiment of the present disclosure;

FIG. 2 is a first schematic diagram of a first example according to an embodiment of the present disclosure;

FIG. 3 is a second schematic diagram of the first example according to an embodiment of the present disclosure;

FIG. 4 is a third schematic diagram of the first example according to an embodiment of the present disclosure;

FIG. 5 is a second flowchart of a communication method provided according to an embodiment of the present disclosure;

FIG. 6 is a third flowchart of a communication method provided according to an embodiment of the present disclosure;

FIG. 7 is a fourth flowchart of a communication method provided according to an embodiment of the present disclosure;

FIG. 8 is a fifth flowchart of a communication method provided according to an embodiment of the present disclosure;

FIG. 9 is a sixth flowchart of a communication method provided according to an embodiment of the present disclosure;

FIG. 10 is a schematic structural diagram of an access point provided according to an embodiment of the present disclosure;

FIG. 11 is a schematic structural diagram of a station provided according to an embodiment of the present disclosure;

FIG. 12 is a schematic structural diagram of an electronic device provided according to an embodiment of the present disclosure.

### DETAILED DESCRIPTION

In the embodiments of the present disclosure, the term “and/or” describes an association relationship between associated objects, indicating that there may be three relationships; for example, A and/or B may indicate that A exists alone, A and B exist at the same time, and B exists alone. The character “/” generally indicates an “or” relationship between the associated objects before and after.

In the embodiments of the present disclosure, the term “a plurality of” means two or more, and other quantifiers are similar with it.

Example embodiments will now be described in detail here, examples of which are illustrated in the accompanying drawings. The following description below refers to the accompanying drawings in which the same numbers in different drawings represent the same or similar elements, unless otherwise represented. The implementations described in the following example embodiments do not represent all implementations consistent with the present disclosure. On the contrary, they are merely examples of apparatuses and methods consistent with some aspects of the present invention as described in the appended claims.

The terms used in the present disclosure are merely for the purpose of describing particular embodiments, and are not intended to limit the present disclosure. As used in the present disclosure and the appended claims, the singular forms “a”, “said”, and “the” are intended to include the plural forms as well, unless the context clearly indicates other meanings. It should also be understood that the term “and/or” as used here refers to and includes any or all possible combinations of one or more associated listed items.

It should be understood that although the terms “first”, “second”, “third”, etc., may be used in the present disclosure to describe various information, the information should not be limited to these terms. These terms are only used to distinguish the same type of information from each other. For example, without departing from the scope of the present disclosure, the first information may also be referred to as second information; and similarly, the second information may also be referred to as first information. Depending on the context, for example, the word “if” used here may be interpreted as “at the time”, “when” or “in response to determining”.

The technical solutions in the embodiments of the present disclosure will be clearly and completely described below with reference to the accompanying drawings in the embodiments of the present disclosure. Obviously, the described embodiments are merely a portion of the embodiments of the present disclosure, and not all the embodiments. All other embodiments obtained by those of ordinary skill in the art based on the embodiments of the present disclosure without creative efforts, shall fall within the protection scope of the present disclosure.

According to Embodiments of the present disclosure, there is provided a communication method and apparatus, an electronic device, and a storage medium, to provide a manner of replying to a sensing measurement proxy request, as to improve the measurement process that an AP initiates a sensing measurement as a proxy of a STA.

Among them, the method and the apparatus are based on the same application concept. Since the principles of using the method and the apparatus to solve the problem are similar with each other, the implementations of the apparatus and the method may refer to each other, and details are not described here again.

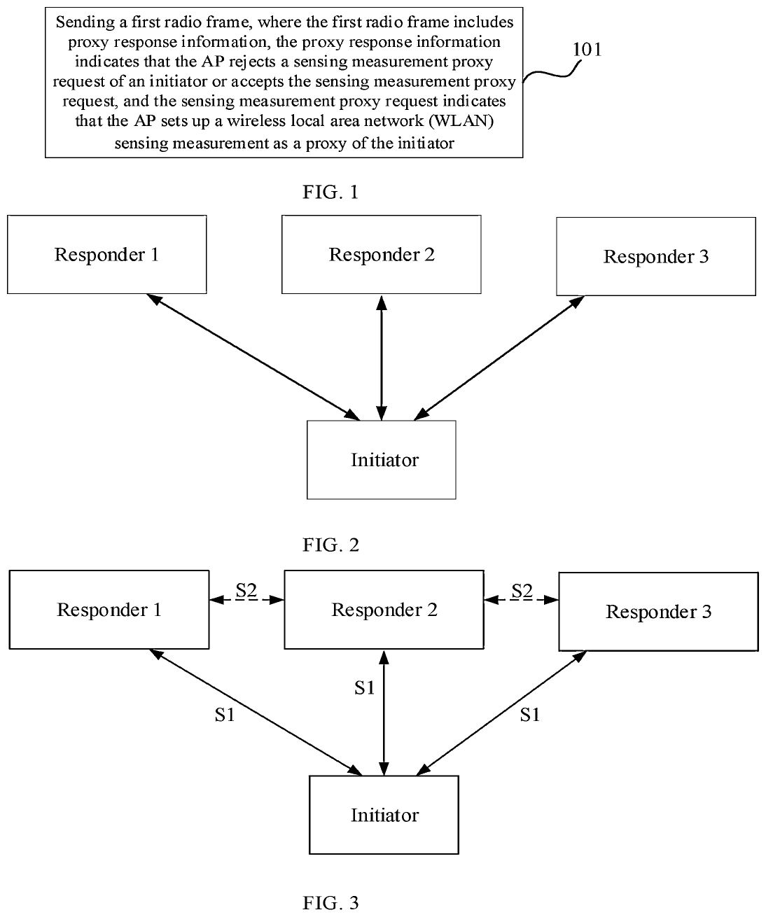

As shown in FIG. 1, according to embodiments of the present disclosure, there is provided a communication method, and in some embodiments, the method may be applied to an access point (AP), and the method may include the following steps.

In step 101, a first radio frame is sent, where the first radio frame includes proxy response information, the proxy response information indicates that the AP rejects a sensing measurement proxy request of an initiator or accepts the sensing measurement proxy request. and the sensing measurement proxy request indicates that the AP sets up a wireless local area network (WLAN) sensing measurement as a proxy of the initiator.

As a first example, referring to FIG. 2 to FIG. 4, a WLAN sensing architecture and a WLAN sensing process applied by the communication method provided according to the embodiments of the present disclosure are described firstly.

FIG. 2 shows a schematic architectural diagram of a WLAN sensing process, where when a sensing initiator (or, an initiator) initiates WLAN sensing (for example, initiating a WLAN sensing session), there may be a plurality of sensing responders (or sensing receivers) or responders that respond to it, such as the responder 1, the responder 2, and the responder 3 shown in FIG. 2. When the sensing initiator initiates the WLAN sensing, the plurality of associated or non-associated sensing responders of the WLAN sensing may respond to it.

Referring to FIG. 3, communication is performed between the sensing initiator and the sensing responder through a communication connection, such as the communication connection S1 shown in the drawing; and communication is performed between the sensing responders through the communication connection S2.

Among them, each sensing initiator may be a client; and each sensing responder (e.g., the sensing responder 1 to the sensing responder 3 in this example) may be a station (STA) or an access point (AP). In addition, the STA and the AP may play a plurality of roles in a WLAN sensing process. For example, in a WLAN sensing process, the STA may also serve as a sensing initiator, and the sensing initiator may be a sensing transmitter, a sensing receiver, or a sensing transmitter and receiver. In a WLAN sensing process, the sensing responder may also be a sensing transmitter, a sensing receiver, or a sensing transmitter and receiver.

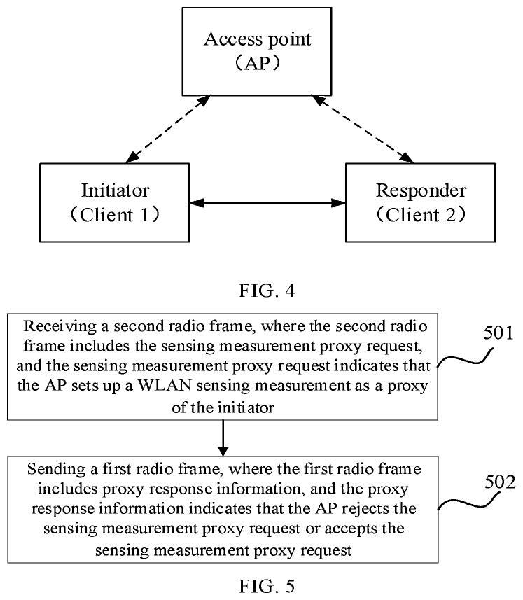

As another architecture, as shown in FIG. 4, the sensing initiator and the sensing responder may both be clients, communication between which may be performed through connection to a same access point (AP). In FIG. 4, Client 1 is a sensing initiator, and Client 2 is a sensing responder.

When the STA is used as a sensing initiator or a sensing transmitter, the STA does not have the function of simultaneously communicating with the plurality of receivers. Therefore, the AP is needed to perform the sensing measurement as a proxy of the STA. In a scenario that the AP performs sensing measurement as a proxy of a requesting STA (that is, a STA that requests the AP to perform the sensing measurement as a proxy of the STA), the STA sends a sensing measurement proxy request to the AP, and the sensing measurement proxy request may be sent through a sensing by proxy (SBP) request frame; and the AP sends a first radio frame to the STA, to indicate the STA whether the STA accepts the proxy request through the first radio frame or not.

In some embodiments, the first radio frame includes proxy response information (i.e., an SBP response), and the proxy response information indicates that the AP rejects a sensing measurement proxy request of an initiator or accepts the sensing measurement proxy request. For example, if the AP cannot satisfy the parameter requirement of the requesting STA, where the parameter requirement may include information such as a bandwidth for the sensing by proxy, for example, 20 MHZ, or may include number spatial stream (NSS) information, such as 4, and if the AP cannot satisfy the corresponding parameter requirement, the AP rejects the sensing measurement proxy request. If the AP can satisfy the parameter requirement of the requesting STA, the AP accepts the sensing measurement proxy request, and sets up a proxy of sensing.

In the embodiments of the present disclosure, the AP sends the first radio frame, where the first radio frame carries the proxy response information, and the proxy response information indicates that the AP rejects the sensing measurement proxy request of the initiator or accepts the sensing measurement proxy request. According to the embodiments of the present disclosure, there is provided a manner of replying to the sensing measurement proxy request, so as to improve the measurement process that the AP initiates the sensing measurement as a proxy of the STA.

Referring to FIG. 5, according to the present disclosure, there is further provided a communication method; and in some embodiments, the method may be applied to an access point (AP), and the method may include the following steps.

In step 501, a second radio frame is received, where the second radio frame includes the sensing measurement proxy request, and the sensing measurement proxy request indicates that the AP sets up a WLAN sensing measurement as a proxy of the initiator.

Among them, when the STA is used as a sensing initiator or a sensing transmitter, the STA does not have the function of simultaneously communicating with a plurality of receivers, and therefore, the AP is needed to perform the sensing measurement as a proxy of the STA. When the STA requests the AP to set up the WLAN sensing measurement as a proxy of the initiator (the STA), the STA sends the second radio frame to the AP to request the AP to initiate the sensing measurement as a proxy of the STA. The second radio frame may be a sensing by proxy (SBP) request frame.

In step 502, a first radio frame is sent, where the first radio frame includes proxy response information, and the proxy response information indicates that the AP rejects the sensing measurement proxy request or accepts the sensing measurement proxy request.

After receiving the second radio frame, the AP sends the first radio frame to the STA; and through the first radio frame, the AP indicates to the STA whether the AP accepts the proxy request.

In some embodiments, the first radio frame includes proxy response information (i.e., an SBP response), and the proxy response information indicates that the AP rejects a sensing measurement proxy request of an initiator or accepts the sensing measurement proxy request. For example, if the AP cannot satisfy the parameter requirement of the requesting STA, where the parameter requirement may include information such as a bandwidth for sensing by proxy, for example, 20 MHZ, or may include number spatial stream (NSS) information, such as 4, and if the AP cannot satisfy the corresponding parameter requirement, the AP rejects the sensing measurement proxy request. If the AP can satisfy the parameter requirement of the requesting STA, the AP accepts the sensing measurement proxy request, and sets up a proxy of sensing.

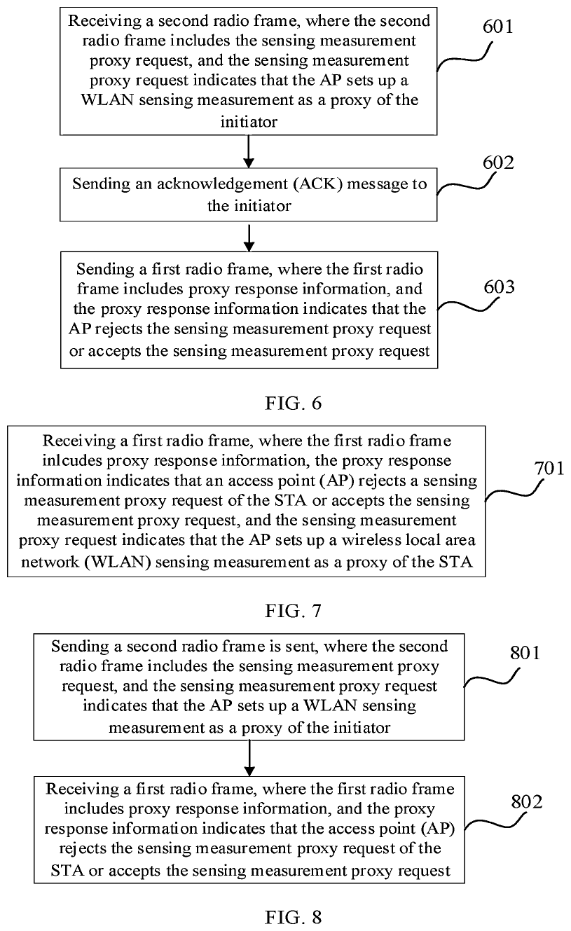

Referring to FIG. 6, according to the present disclosure, there is further provided a communication method; and in some embodiments, the method may be applied to an access point (AP), and the method may include the following steps.

In step 601, a second radio frame is received, where the second radio frame includes the sensing measurement proxy request, and the sensing measurement proxy request indicates that the AP sets up a WLAN sensing measurement as a proxy of the initiator.

Among them, when the STA is used as a sensing initiator or a sensing transmitter, the STA does not have the function of simultaneously communicating with a plurality of receivers, and therefore, the AP is needed to perform the sensing measurement as a proxy of the STA. When the STA requests the AP to set up the WLAN sensing measurement as a proxy of the initiator (the STA), the STA sends the second radio frame to the AP to request the AP to initiate the sensing measurement as a proxy of the STA. The second radio frame may be a sensing by proxy (SBP) request frame.

In step 602, an acknowledgement (ACK) message is sent to the initiator.

Among them, after receiving the second radio frame, the AP sends an acknowledgement (ACK) message to the initiator, and acknowledges that the second radio frame is received.

In step 603, a first radio frame is sent, where the first radio frame includes proxy response information, and the proxy response information indicates that the AP rejects the sensing measurement proxy request or accepts the sensing measurement proxy request.

After receiving the second radio frame, the AP sends the first radio frame to the STA; and through the first radio frame, the AP indicates to the STA whether the AP accepts the proxy request or not. The first radio frame includes proxy response information (i.e., an SBP response), and the proxy response information indicates that the AP rejects a sensing measurement proxy request of an initiator or accepts the sensing measurement proxy request. For example, if the AP cannot satisfy the parameter requirement of the requesting STA, where the parameter requirement may include information such as a bandwidth for the sensing by proxy, for example, 20 MHZ, or may include number spatial stream (NSS) information, such as 4, and if the AP cannot satisfy the corresponding parameter requirement, the AP rejects the sensing measurement proxy request. If the AP can satisfy the parameter requirement of the requesting STA, the AP accepts the sensing measurement proxy request, and sets up a proxy of sensing.

In some embodiments, in a case that the proxy response information indicates that the AP rejects the sensing measurement proxy request, the first radio frame includes a rejection identification, and the rejection identification indicates a reason code that the AP rejects the sensing measurement proxy request. For example, one bit is occupied in the first radio frame to represent the rejection identification. For example, the bit is set to “0”, to identify that the AP rejects the request of the requesting STA, the AP does not set up a proxy of sensing, and that the subsequent SBP response frame does not include a sensing measurement setup identification (ID).

Among them, the first radio frame may further carry a reason code for rejection, to identify the reason why the AP rejects to sets up the proxy. Furthermore, in some embodiments, the rejection identification includes a first identification or a second identification.

The first identification indicates that the AP does not satisfy an operation parameter requirement in the sensing measurement proxy request. For example, in a current network environment, the AP cannot satisfy the parameter requirement of the requesting STA in the request frame.

The second identification indicates that the AP provides optional operation parameter information for the initiator. The AP may further recommend new optional operation parameter information to the requesting STA. The optional operation parameter information may need to be acknowledged by the requesting STA, or may not need to be acknowledged.

In some embodiments, in a case that the proxy response information indicates that the AP accepts the sensing measurement proxy request, the first radio frame includes a sensing measurement setup identification or a WLAN session identification of the WLAN sensing measurement.

In some embodiments, one bit may be occupied in the first radio frame to represent an acceptance identification. For example, the bit is set to “1”, to identify that the AP accepts the request of the requesting STA and sets up a proxy of sensing, and subsequently the first radio frame includes the sensing measurement setup identification or the WLAN session identification.

In some embodiments, the first radio frame is a public action frame. The public action frame includes a public action field corresponding to the first radio frame. The public action frame may be identified as a second radio frame (an SBP request frame) or a first radio frame (an SBP response frame) through a public action value in the public action field.

In the embodiments of the present disclosure, the AP sends the first radio frame, where the first radio frame carries the proxy response information, and the proxy response information indicates that the AP rejects the sensing measurement proxy request of the initiator or accepts the sensing measurement proxy request. According to the embodiments of the present disclosure, there is provided a manner of replying to the sensing measurement proxy request, so as to improve the measurement process that the AP initiates the sensing measurement as a proxy of the STA.

As shown in FIG. 7, according to embodiments of the present disclosure, there is further provided a communication method; and in some embodiments, the method may be applied to a station (STA), and the method includes the following step.

In step 701, a first radio frame is received, where the first radio frame includes proxy response information, the proxy response information indicates that an access point (AP) rejects a sensing measurement proxy request of the STA or accepts the sensing measurement proxy request, and the sensing measurement proxy request indicates that the AP sets up a WLAN sensing measurement as a proxy of the STA.

As a first example, referring to FIG. 2 to FIG. 4, a WLAN sensing architecture and a WLAN sensing process applied by the communication method provided in the embodiments of the present disclosure are described. The details may refer to the foregoing embodiments, and will not be described here again.

When the STA is used as a sensing initiator or a sensing transmitter, the STA does not have the function of simultaneously communicating with a plurality of receivers, and therefore, the AP is needed to perform the sensing measurement as a proxy of the STA. In a scenario that the AP performs the sensing measurement as a proxy of a requesting STA (that is, a STA that requests the AP to perform the sensing measurement as a proxy of the STA), the STA sends a sensing measurement proxy request to the AP, and the sensing measurement proxy request may be sent through a sensing by proxy (SBP) request frame. The AP sends a first radio frame to the STA. The STA receives the first radio frame, and determines whether the AP accepts the sensing measurement proxy request through the first radio frame.

In some embodiments, the first radio frame includes proxy response information (i.e., an SBP response), and the proxy response information indicates that the AP rejects a sensing measurement proxy request of an initiator or accepts the sensing measurement proxy request. For example, if the AP cannot satisfy the parameter requirement of the requesting STA, where the parameter requirement may include information such as a bandwidth for the sensing by proxy, for example, 20 MHZ, or may include number spatial stream (NSS) information, such as 4, and if the AP cannot satisfy the corresponding parameter requirement, the AP rejects the sensing measurement proxy request. If the AP can satisfy the parameter requirement of the requesting STA, the AP accepts the sensing measurement proxy request, and sets up a proxy of sensing.

In the embodiments of the present disclosure, the STA receives the first radio frame, where the first radio frame carries the proxy response information, and the proxy response information indicates that the AP rejects the sensing measurement proxy request of the initiator or accepts the sensing measurement proxy request. According to the embodiments of the present disclosure, there is provided a manner of replying to the sensing measurement proxy request, so as to improve the measurement process that the AP initiates the sensing measurement as a proxy of the STA.

Referring to FIG. 8, according to the present disclosure, there is further provided a communication method; and in some embodiments, the method may be applied to a station (STA), and the method includes following steps.

In step 801, a second radio frame is sent, where the second radio frame includes the sensing measurement proxy request, and the sensing measurement proxy request indicates that the AP sets up a WLAN sensing measurement as a proxy of the initiator.

Among them, when the STA is used as a sensing initiator or a sensing transmitter, the STA does not have the function of simultaneously communicating with a plurality of receivers, and therefore, the AP is needed to perform the sensing measurement as a proxy of the STA. When the STA requests the AP to sets up the WLAN sensing measurement as a proxy of the initiator (the STA), the STA sends the second radio frame to the AP to request the AP to initiate the sensing measurement as a proxy of the STA. The second radio frame may be a sensing by proxy (SBP) request frame.

In step 802, a first radio frame is received, where the first radio frame includes proxy response information, and the proxy response information indicates that the access point (AP) rejects the sensing measurement proxy request of the STA or accepts the sensing measurement proxy request.

The AP sends the first radio frame to the STA. The STA receives the first radio frame, and determines whether the AP accepts the sensing measurement proxy request through the first radio frame.

In some embodiments, the first radio frame includes proxy response information (i.e., an SBP response), and the proxy response information indicates that the AP rejects a sensing measurement proxy request of an initiator or accepts the sensing measurement proxy request. For example, if the AP cannot satisfy the parameter requirement of the requesting STA, where the parameter requirement may include information such as a bandwidth for sensing by proxy, for example, 20 MHZ, or may include number spatial stream (NSS) information, such as 4, and if the AP cannot satisfy the corresponding parameter requirement, the AP rejects the sensing measurement proxy request. If the AP can satisfy the parameter requirement of the requesting STA, the AP accepts the sensing measurement proxy request, and sets up a proxy of sensing.

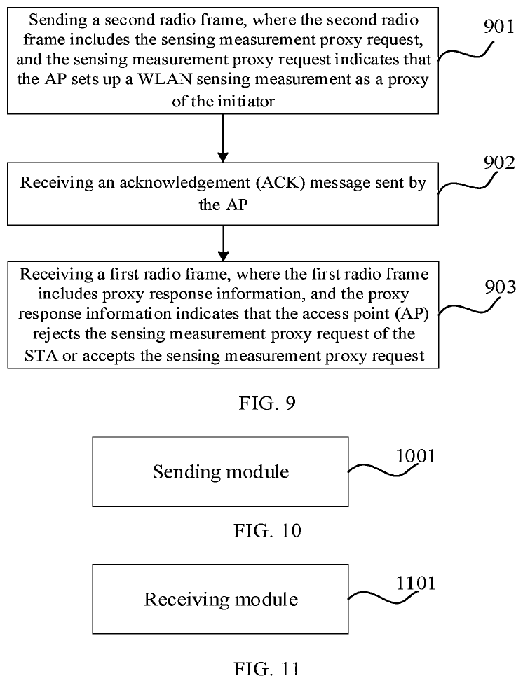

Referring to FIG. 9, according to the present disclosure, there is further provided a communication method; and in some embodiments, the method may be applied to a station (STA), and the method includes the following steps.

In step 901, a second radio frame is sent, where the second radio frame includes the sensing measurement proxy request, and the sensing measurement proxy request indicates that the AP sets up a WLAN sensing measurement as a proxy of the initiator.

Among them, when the STA is used as a sensing initiator or a sensing transmitter, the STA does not have the function of simultaneously communicating with a plurality of receivers, and therefore, the AP is needed to perform the sensing measurement as a proxy of the STA. When the STA requests the AP to sets up the WLAN sensing measurement as a proxy of the initiator (the STA), the STA sends the second radio frame to the AP to request the AP to initiate the sensing measurement as a proxy of the STA. The second radio frame may be a sensing by proxy (SBP) request frame.

In step 902, an acknowledgement (ACK) message sent by the AP is received.

Among them, after receiving the second radio frame, the AP sends an acknowledgement (ACK) message to the initiator, and acknowledges that the second radio frame is received.

In step 903, a first radio frame is received, where the first radio frame includes proxy response information, and the proxy response information indicates that the access point (AP) rejects the sensing measurement proxy request of the STA or accepts the sensing measurement proxy request.

The AP sends the first radio frame to the STA. The STA receives the first radio frame, and determines whether the AP accepts the sensing measurement proxy request through the first radio frame.

In some embodiments, the first radio frame includes proxy response information (i.e., an SBP response), and the proxy response information indicates that the AP rejects a sensing measurement proxy request of an initiator or accepts the sensing measurement proxy request. For example, if the AP cannot satisfy the parameter requirement of the requesting STA, where the parameter requirement may include information such as a bandwidth for sensing by proxy, for example, 20 MHZ, or may include number spatial stream (NSS) information, such as 4, and if the AP cannot satisfy the corresponding parameter requirement, the AP rejects the sensing measurement proxy request. If the AP can satisfy the parameter requirement of the requesting STA, the AP accepts the sensing measurement proxy request, and sets up a proxy of sensing.

In some embodiments, in a case that the proxy response information indicates that the AP rejects the sensing measurement proxy request, the first radio frame includes a rejection identification, and the rejection identification indicates a reason code that the AP rejects the sensing measurement proxy request. For example, one bit is occupied in the first radio frame to represent the rejection identification. For example, the bit is set to “0”, to identify that the AP rejects the request of the requesting STA, the AP does not set up a proxy of sensing, and that the subsequent SBP response frame does not include a sensing measurement setup identification (ID).

Among them, the first radio frame may further carry a reason code for rejection, to identify the reason why the AP rejects to sets up the proxy. Furthermore, in some embodiments, the rejection identification includes a first identification or a second identification.

The first identification indicates that the AP does not satisfy an operation parameter requirement in the sensing measurement proxy request. For example, in a current network environment, the AP cannot satisfy the parameter requirement of the requesting STA in the request frame.

The second identification indicates that the AP provides optional operation parameter information for the initiator. The AP may further recommend new optional operation parameter information to the requesting STA. The optional operation parameter information may need to be acknowledged by the requesting STA, or may not need to be acknowledged.

In some embodiments, in a case that the proxy response information indicates that the AP accepts the sensing measurement proxy request, the first radio frame includes a sensing measurement setup identification of the WLAN sensing measurement. In some embodiments, one bit may be occupied in the first radio frame to represent an acceptance identification. For example, the bit is set to “1”, to identify that the AP accepts the request of the requesting STA and sets up a proxy of sensing, and subsequently the first radio frame includes the sensing measurement setup identification or the WLAN session identification.

In some embodiments, the first radio frame is a public action frame. The public action frame includes a public action value corresponding to the first radio frame. The public action frame includes a public action field corresponding to the first radio frame. The public action frame may be identified as a second radio frame (an SBP request frame) or a first radio frame (an SBP response frame) through the public action value in the public action field.

In the embodiments of the present disclosure, the STA receives the first radio frame, where the first radio frame carries the proxy response information, and the proxy response information indicates that the AP rejects the sensing measurement proxy request of the initiator or accepts the sensing measurement proxy request. According to the embodiments of the present disclosure, there is provided a manner of replying to the sensing measurement proxy request, so as to improve the measurement process that the AP initiates the sensing measurement as a proxy of the STA.

Based on the same principle as the method provided in the embodiments of the present disclosure, according to embodiments of the present disclosure, there is further provided an access point (AP). Referring to FIG. 10, the access point includes a sending module 1001.

The sending module 1001 is configured to send a first radio frame, where the first radio frame includes proxy response information, the proxy response information indicates that the AP rejects a sensing measurement proxy request of an initiator or accepts the sensing measurement proxy request, and the sensing measurement proxy request indicates that the AP sets up a wireless local area network (WLAN) sensing measurement as a proxy of the initiator.

In the embodiments of the present disclosure, the access point includes a first receiving module.

In some embodiments, the first receiving module is configured to receive a second radio frame, where the second radio frame includes the sensing measurement proxy request.

In some embodiments, the first receiving module is configured to receive the second radio frame, send an acknowledgement (ACK) message to the initiator, and sets up the WLAN sensing measurement.

In the embodiments of the present disclosure, in a case that the proxy response information indicates that the AP rejects the sensing measurement proxy request, the first radio frame includes a rejection identification, and the rejection identification indicates a reason code that the AP rejects the sensing measurement proxy request.

In the embodiments of the present disclosure, the rejection identification includes a first identification or a second identification.

The first identification indicates that the AP does not satisfy an operation parameter requirement in the sensing measurement proxy request.

The second identification indicates that the AP provides optional operation parameter information for the initiator.

In the embodiments of the present disclosure, in a case that the proxy response information indicates that the AP accepts the sensing measurement proxy request, the first radio frame includes a sensing measurement setup identification or a WLAN session identification of the WLAN sensing measurement.

In the embodiments of the present disclosure, the first radio frame is a public action frame.

The public action frame includes a public action field corresponding to the first radio frame.

According to the access point provided in the present disclosure, the sending module 1001 sends a first radio frame, where the first radio frame carries the proxy response information, and the proxy response information indicates that the AP rejects the sensing measurement proxy request of the initiator or accepts the sensing measurement proxy request. According to embodiments of the present disclosure, there is provided a manner of replying to the sensing measurement proxy request, so as to improve the measurement process that the AP initiates the sensing measurement as a proxy of the STA.

According to embodiments of the present disclosure, there is further provided a communication apparatus, applied to an access point (AP) and including a radio frame sending module.

The radio frame sending module is configured to send a first radio frame, where the first radio frame includes proxy response information, the proxy response information indicates that the AP rejects a sensing measurement proxy request of an initiator or accepts the sensing measurement proxy request, and the sensing measurement proxy request indicates that the AP sets up a wireless local area network (WLAN) sensing measurement as a proxy of the initiator.

The apparatus further includes other modules of the access point (AP) in the foregoing embodiments, and details are not described here again.

Based on the same principle as the method provided in the embodiments of the present disclosure, according to embodiments of the present disclosure, there is further provided a station (STA). Referring to FIG. 11, the station includes a receiving module 1101.

The receiving module 1101 is configured to receive a first radio frame, where the first radio frame includes proxy response information, the proxy response information indicates that an access point (AP) rejects a sensing measurement proxy request of the STA or accepts the sensing measurement proxy request, and the sensing measurement proxy request indicates that the AP sets up a wireless local area network (WLAN) sensing measurement as a proxy of the STA.

In the embodiments of the present disclosure, the station includes a first sending module.

The first sending module is configured to send a second radio frame, where the second radio frame includes the sensing measurement proxy request.

In the embodiments of the present disclosure, the station includes a message receiving module.

The message receiving module is configured to receive an acknowledgement (ACK) message sent by the AP.

In the embodiments of the present disclosure, in a case that the proxy response information indicates that the AP rejects the sensing measurement proxy request, the first radio frame includes a rejection identification, and the rejection identification indicates a reason code that the AP rejects the sensing measurement proxy request.

In the embodiments of the present disclosure, the rejection identification includes a first identification or a second identification.

The first identification indicates that the AP does not satisfy an operation parameter requirement in the sensing measurement proxy request.

The second identification indicates that the AP provides optional operation parameter information for the STA.

In the embodiments of the present disclosure, in a case that the proxy response information indicates that the AP accepts the sensing measurement proxy request, the first radio frame includes a sensing measurement setup identification of the WLAN sensing measurement.

In the embodiments of the present disclosure, the first radio frame is a public action frame.

The public action frame includes a public action value corresponding to the first radio frame.

In the embodiments of the present disclosure, the receiving module 1101 receives the first radio frame, where the first radio frame carries the proxy response information, and the proxy response information indicates that the AP rejects the sensing measurement proxy request of the initiator or accepts the sensing measurement proxy request. According to embodiments of the present disclosure, there is provided a manner of replying to the sensing measurement proxy request, so as to improve the measurement process that the AP initiates the sensing measurement as a proxy of the STA.

According to embodiments of the present disclosure, there is further provided a communication apparatus, applied to a station (STA), and the apparatus includes a radio frame receiving module.

The radio frame receiving module is configured to receive a first radio frame, where the first radio frame includes proxy response information, the proxy response information indicates that an access point (AP) rejects a sensing measurement proxy request of the STA or accepts the sensing measurement proxy request, and the sensing measurement proxy request indicates that the AP sets up a wireless local area network (WLAN) sensing measurement as a proxy of the STA.

The apparatus further includes other modules of the station (STA) in the foregoing embodiment, and details are not described here again.

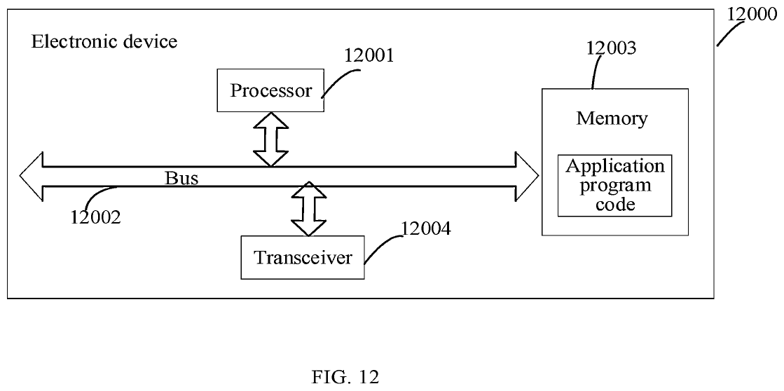

In some embodiments, according to embodiments of the present disclosure, there is further provided an electronic device, as shown in FIG. 12. The electronic device 12000 shown in FIG. 12 may be a server, including a processor 12001 and a memory 12003, where the processor 12001 is connected to the memory 12003, for example, through a bus 12002. in some embodiments, the electronic device 12000 may further include a transceiver 12004. It should be noted that the number of the transceiver 12004 in actual applications is not limited to one, and the structure of the electronic device 12000 does not constitute a limitation on the embodiments of the present disclosure.

The processor 12001 may be a central processing unit (CPU), a general-purpose processor, a digital signal processor (DSP), an application-specific integrated circuit (ASIC), a field programmable gate array (FPGA), or another programmable logic device, a transistor logic device, a hardware component, or any combination of them. The processor may implement or execute various example logical blocks, modules, and circuits described with reference to content disclosed in the present disclosure. Alternatively, the processor 12001 may be a combination for implementing a computing function, for example, a combination of one or more microprocessors, or a combination of a DSP and a microprocessor.

The bus 12002 may include a path for transmitting information between the foregoing components. The bus 12002 may be a peripheral component interconnect (PCI) bus, an extended industry standard architecture (EISA) bus, or the like. The bus 12002 may be classified into an address bus, a data bus, a control bus, or the like. For ease of representation, only a thick line is used to represent the bus in FIG. 12, but this does not mean that there is only one bus or only one type of bus.

The memory 12003 may be a read only memory (ROM) or another type of static storage device that may store static information and instructions, a random access memory (RAM) or another type of dynamic storage device that may store information and instructions; the memory 12003 may also be an electrically erasable programmable read only memory (EEPROM), a compact disk read only memory (CD-ROM), or other CD storage, optical disk storage (including compact disk, laser disk, optical disk, digital universal disk, blue-ray disk, etc.), magnetic disk storage medium, or other magnetic storage device, or any other medium that can be used to carry or store desired program code in the form of instructions or data structures and that can be accessed by a computer, which is not limited to this.

The memory 12003 is configured to store application program code for executing the solution of the present disclosure, and the processor 12001 is configured to control the execution. The processor 12001 is configured to execute the application program code stored in the memory 12003, to implement the content shown in the foregoing method embodiments.

Among them, the electronic device includes, but is not limited to, a mobile terminal such as a mobile phone, a notebook computer, a digital broadcast receiver, a personal digital assistant (PDA), a tablet computer (PAD), a portable multimedia player (PMP), a vehicle-mounted terminal (for example, a vehicle-mounted navigation terminal), or the like, and a fixed terminal such as a digital TV, a desktop computer, or the like. The electronic device shown in FIG. 12 is merely an example, and should not bring any limitation on the function and scope of use of the embodiments of the present disclosure.

The server provided in the present disclosure may be an independent physical server, or may be a server cluster or a distributed system composed of a plurality of physical servers, or may be a cloud server that provides basic cloud computing services such as a cloud service, a cloud database, a cloud computing, a cloud function, cloud storage, a network service, a cloud communication, a middleware service, a domain name service, a security service, a CDN, and a big data and artificial intelligence platform. The terminal may be a smartphone, a tablet computer, a notebook computer, a desktop computer, a smart speaker, a smartwatch, or the like, but is not limited to this. The terminal and the server may be directly or indirectly connected to each other in a wired or wireless communication manner, which is not limited in the present disclosure.

According to embodiments of the present disclosure, there is provided a computer-readable storage medium. The computer-readable storage medium stores a computer program, and when the computer program runs on a computer, the computer can perform corresponding content in the foregoing method embodiments.

It should be understood that, although the steps in the flowcharts of the accompanying drawings are sequentially displayed according to the indication of the arrows, the steps are not necessarily performed in sequence according to the order indicated by the arrows. Unless explicitly stated here, the execution of these steps is not strictly limited in order, and may be executed in other orders. Moreover, at least a part of the steps in the flowcharts of the accompanying drawings may include a plurality of sub-steps or a plurality of stages. The sub-steps or sub-stages are not necessarily performed at the same moment, but may be executed at different moments; and the execution order of them is not necessarily performed in sequence, but may be performed in turn or alternately with at least a part of sub-steps or sub-stages of other steps or other steps.

It should be noted that the computer-readable medium according to the present disclosure may be a computer-readable signal medium or a computer-readable storage medium or any combination of the two. The computer-readable storage medium may be, for example, but not limited to, an electronic, magnetic, optical, electromagnetic, infrared, or semiconductor system, apparatus, or device, or any combination of them. A more specific example of a computer-readable storage medium may include, but is not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be used by or in combination with an instruction execution system, apparatus, or device. In the present disclosure, the computer-readable signal medium may include a data signal propagated in a baseband or as a part of a carrier, and the computer-readable signal medium carries computer-readable program code. The propagated data signal may take various forms, including but not limited to an electromagnetic signal, an optical signal, or any suitable combination of the foregoing. The computer-readable signal medium may also be any computer-readable medium other than a computer-readable storage medium, and the computer-readable signal medium may send, propagate, or transmit a program for use by or in connection with an instruction execution system, apparatus, or device. The program code included on the computer readable medium may be transmitted by using any suitable medium, including but not limited to: an electric wire, an optical cable, a radio frequency (RF), etc., or any suitable combination of the above.

The computer-readable medium may be included in the electronic device, or may exist alone without being assembled into the electronic device.

The computer-readable medium carries one or more programs, and when the one or more programs are executed by the electronic device, the electronic device is enabled to perform the method shown in the foregoing embodiments.

According to an aspect of the present disclosure, there is provided a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, so that the computer device performs the method provided in the foregoing optional implementations.

Computer program code for performing the operations of the present disclosure may be written in one or more programming languages or their combinations. The programming languages include object-oriented programming languages, such as Java, Smalltalk, C++, and conventional procedural programming languages, such as the “C” language or similar programming languages. The program code may be executed entirely on the user's computer, partly on the user's computer, as a stand-alone software package, partly on the user's computer and partly on a remote computer, or entirely on the remote computer or server. In the case of a remote computer, the remote computer may be connected to the user's computer through any type of network, including a local area network (LAN) or a wide area network (WAN), or may be connected to an external computer (for example, to be connected via the Internet using an Internet service provider).

The flowchart and block diagrams in the drawings illustrate the architecture, function, and operation of possible implementations of systems, methods, and computer program products according to various embodiments of the present disclosure. In this regard, each block in the flowchart or block diagrams may represent a module, a program segment, or a portion of code, which includes one or more executable instructions for implementing the specified logical function. It should also be noted that, in some alternative implementations, the functions noted in the blocks may occur in a different order from the order noted in the drawings. For example, two blocks shown in succession may, in fact, be executed substantially concurrently, or may sometimes be executed in a reverse order, depending upon the functions involved. It will also be noted that each block in the block diagrams and/or the flowchart, and combinations of blocks in the block diagrams and/or the flowchart, can be implemented by dedicated hardware-based systems that perform the specified functions or operations, or by combinations of dedicated hardware and computer instructions.

The modules involved in the embodiments of the present disclosure may be implemented by software, or may be implemented by hardware. Among them, the name of the module does not constitute a limitation on the module itself in some cases; for example, the module A may also be described as “a module A for performing an operation B”.

The foregoing is only a description of the preferred embodiments of the present disclosure and the applied technical principles. It should be understood by those skilled in the art that the disclosed scope involved in the present disclosure is not limited to the technical solutions formed by the specific combinations of the above technical features, and also covers other technical solutions formed by any combination of the above technical features or equivalent features of them without departing from the above disclosure, such as, technical solutions formed by replacing the above features with (but not limited to) technical features having similar functions disclosed in the present disclosure.

1. A communication method, performed by an access point (AP), wherein the method comprises:
sending a first radio frame, wherein the first radio frame comprises proxy response information indicating that the AP rejects a sensing measurement proxy request of an initiator or accepts the sensing measurement proxy request, and wherein the sensing measurement proxy request indicates that the AP sets up a wireless local area network (WLAN) sensing measurement as a proxy of the initiator.

2. The communication method according to claim 1, further comprising:
receiving a second radio frame, wherein the second radio frame comprises the sensing measurement proxy request.

3. The communication method according to claim 1, wherein the proxy response information indicates that the AP rejects the sensing measurement proxy request, and the first radio frame comprises a rejection identification, and wherein the rejection identification indicates a reason code that the AP rejects the sensing measurement proxy request.

4. The communication method according to claim 3, wherein the rejection identification comprises a first identification or a second identification, and wherein
the first identification indicates that the AP does not satisfy an operation parameter requirement in the sensing measurement proxy request, and
the second identification indicates that the AP provides optional operation parameter information for the initiator.

5. The communication method according to claim 1, wherein the proxy response information indicates that the AP accepts the sensing measurement proxy request, and the first radio frame comprises a sensing measurement setup identification or a WLAN session identification of the WLAN sensing measurement.

6. The communication method according to claim 1, wherein the first radio frame is a pubic action frame, and wherein
the public action frame comprises a public action field corresponding to the first radio frame.

7. A communication method, performed by a station (STA), wherein the method comprises:
receiving a first radio frame, wherein the first radio frame comprises proxy response information indicating that an access point (AP) rejects a sensing measurement proxy request of the STA or accepts the sensing measurement proxy request, and wherein the sensing measurement proxy request indicates that the AP sets up a wireless local area network (WLAN) sensing measurement as a proxy of the STA.

8. The communication method according to claim 7, further comprising:
sending a second radio frame, wherein the second radio frame comprises the sensing measurement proxy request.

9. The communication method according to claim 8, further comprising:
receiving an acknowledgement (ACK) message sent by the AP.

10. The communication method according to claim 7, wherein the proxy response information indicates that the AP rejects the sensing measurement proxy request, and the first radio frame comprises a rejection identification, and wherein the rejection identification indicates a reason code that the AP rejects the sensing measurement proxy request.

11. The communication method according to claim 10, wherein the rejection identification comprises a first identification or a second identification, wherein
the first identification indicates that the AP does not satisfy an operation parameter requirement in the sensing measurement proxy request, and
the second identification indicates that the AP provides optional operation parameter information for the STA.

12. The communication method according to claim 7, wherein the proxy response information indicates that the AP accepts the sensing measurement proxy request, and the first radio frame comprises a sensing measurement setup identification of the WLAN sensing measurement.

13. The communication method according to claim 7, wherein the first radio frame is a pubic action frame, and wherein
the public action frame comprises a public action value corresponding to the first radio frame.

14-17. (canceled)

18. An electronic device, comprising a memory and a processor, wherein the memory stores a computer program, which when executed by the processor, causes the electronic device to perform a communication method, the method comprising:
sending a first radio frame, wherein the first radio frame comprises proxy response information indicating that an access point (AP) rejects a sensing measurement proxy request of an initiator or accepts the sensing measurement proxy request, and wherein the sensing measurement proxy request indicates that the AP sets up a wireless local area network (WLAN) sensing measurement as a proxy of the initiator.

19. (canceled)

20. The communication method according to claim 2, further comprising:
sending an acknowledgement (ACK) message to the initiator; and
setting up the WLAN sensing measurement.

21. The communication method according to claim 1, wherein the sensing measurement proxy request is sent through a sensing by proxy (SBP) request frame.

22. The communication method according to claim 4, wherein the operation parameter requirement comprises a bandwidth for sensing by proxy and number spatial stream (NSS) information.

23. The communication method according to claim 1, wherein the proxy response information indicates that the AP accepts the sensing measurement proxy request, and the first radio frame comprises an acceptance identification.

24. An electronic device, comprising a memory and a processor, wherein the memory stores a computer program, which when executed by the processor, causes the electronic device to perform the method according to claim 7.
